(19) United States
(12) Patent Application Publication
(10) Pub. No.: US 2006/0250108 A1
(43) Pub. Date: Nov. 9, 2006

(54) SUPPLEMENTAL BATTERY FOR A PORTABLE ELECTRONIC DEVICE

(76) Inventors: Kristina Pettigrew, Champaign, IL (US); Tracey Pettigrew, Champaign, IL (US)

Correspondence Address: MICHAEL BERNS;MALONEY, PARKINSON AND BERNS, 135 W MAIN STREET, URBANA, IL, 61801, US

(21) Appl. No.: 11/381,444

(22) Filed: May 3, 2006

Related U.S. Application Data
(60) Provisional application No. 60/676,798, filed on May 3, 2005.

(51) Int. Cl. H02J 7/00

(52) U.S. Cl. 320/107

(57) ABSTRACT

A supplemental battery is provided for portable electronic devices. The electronic device battery may be charged by a supplemental battery.

### CROSS-REFERENCE TO RELATED APPLICATION

Applicant claims the benefit of provisional application 60/676,798, filed May 3, 2005.

### BACKGROUND OF THE INVENTION

The invention relates to a secondary battery for use with portable electronic devices. When the device is docked into a holster, an additional battery provides recharging to the device battery.

### SUMMARY OF THE INVENTION

This invention provides a storage clip with a battery to give longer battery life for portable electrical devices. For a embodiment adapted for a mobile phone, the mobile phone could attach to a clip that could attach to a belt, just like other belt holsters, however, when the device was in the holster, the device battery could be charging.

The clip is designed to give longer battery life for frequently used portable electrical devices such as mobile telephones. Mobile telephones do many more things now, using color screens, cameras and games, all of which use additional battery capacity. Some mobile telephone users are away from electrical outlets or car chargers and can not charge the telephone during the day. Larger batteries can provide more charge capacity, however, the weight and bulk of the larger devices make them undesirable. When the additional battery capacity is worn on the belt, the user does not feel the extra weight as much, and the added bulk is not difficult to work with.

### DESCRIPTION OF THE DRAWINGS

FIG. 1 is side view of an embodiment of the invention for wireless phones.

FIG. 2 is an electrical diagram of an embodiment of the invention.

FIG. 3 is a front view of an embodiment of the invention for wireless phones.

FIG. 4 is a sketch of an embodiment for a cellular telephone.

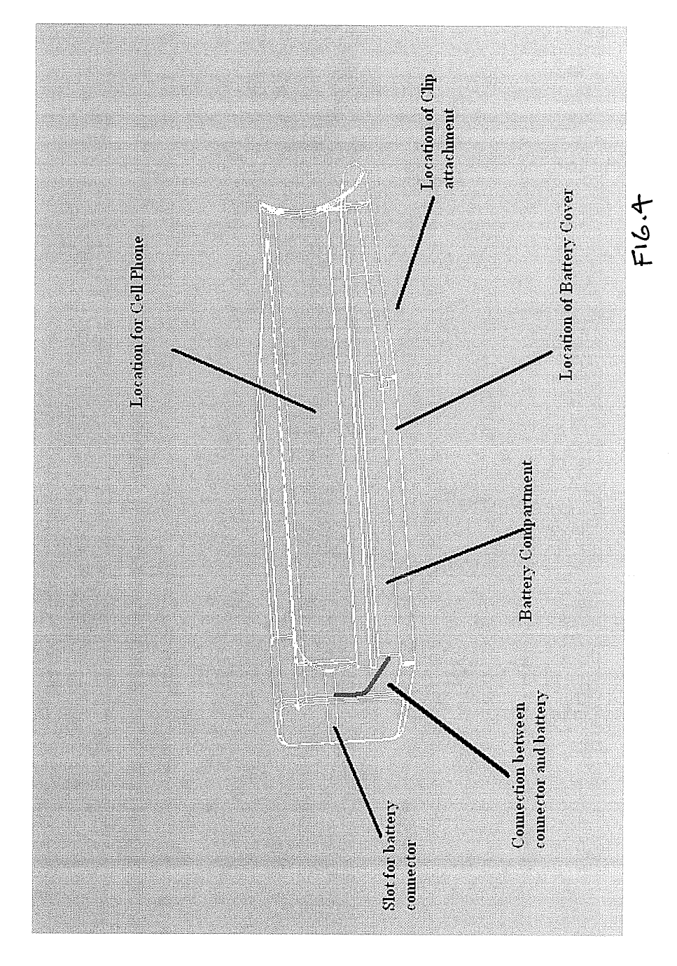

FIG. 5 is a rendering of an embodiment of the invention.

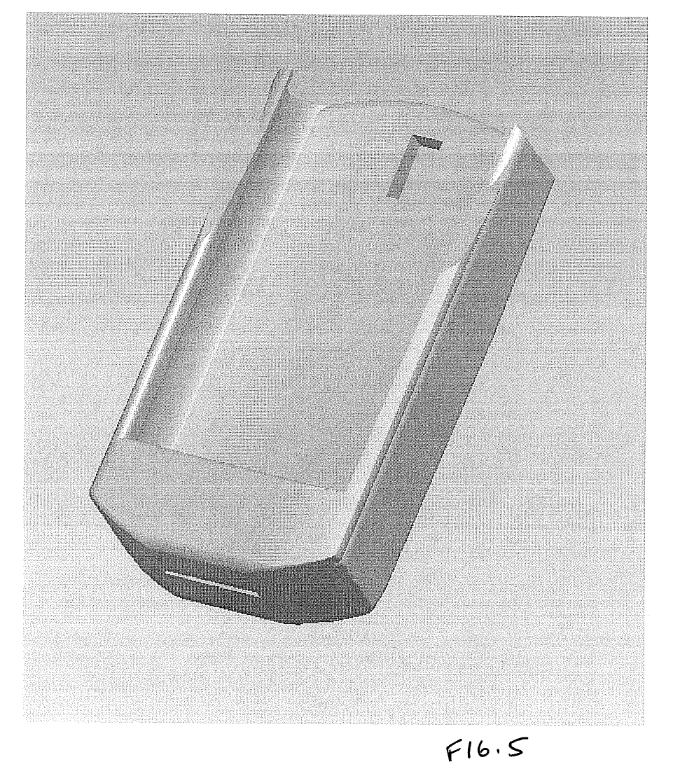

FIG. 6 is a rendering of a rear oblique view of an embodiment showing a clip.

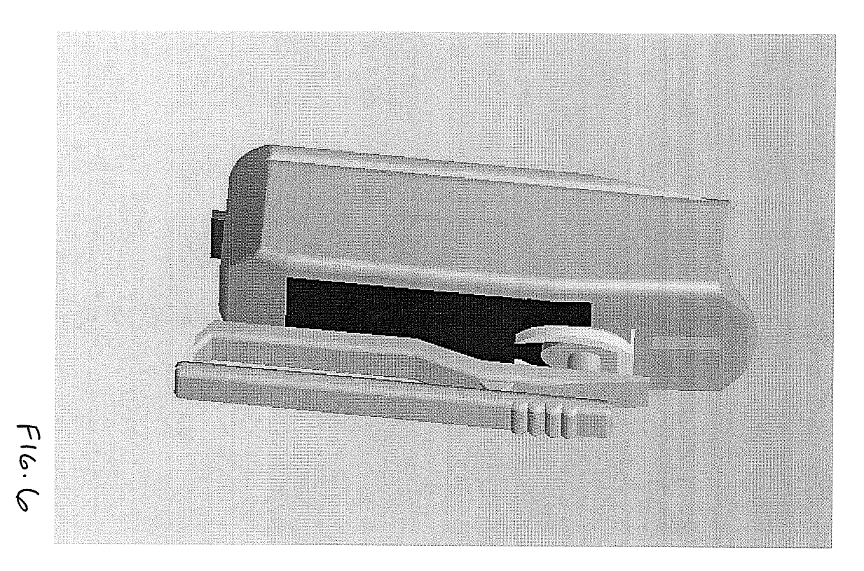

FIG. 7 is a rendering of a rear oblique view of an embodiment showing a clip.

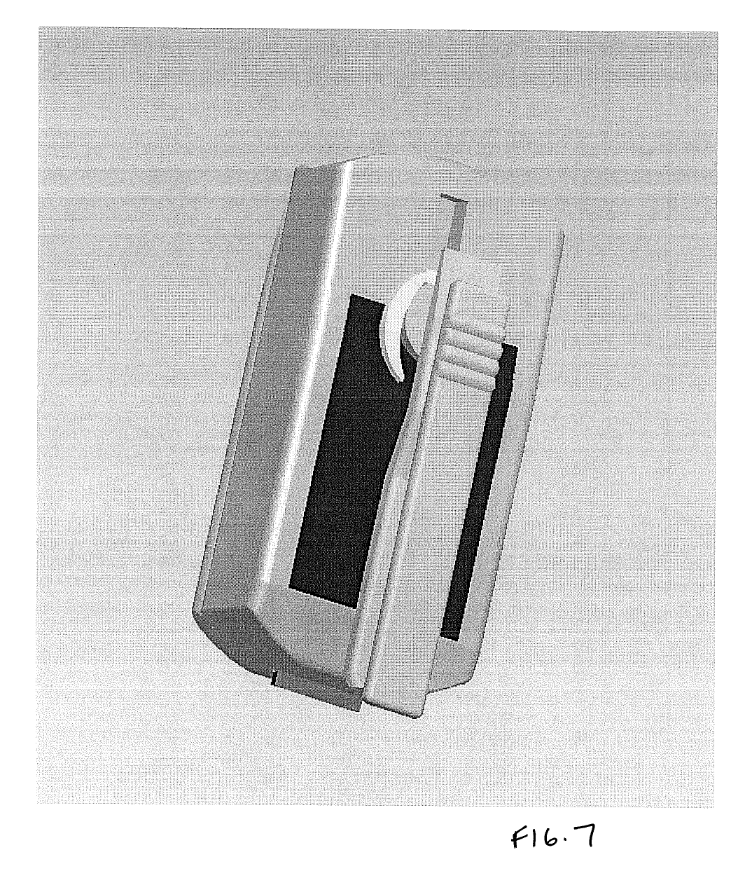

FIG. 8 is a rendering of a rear oblique view of an embodiment without the clip.

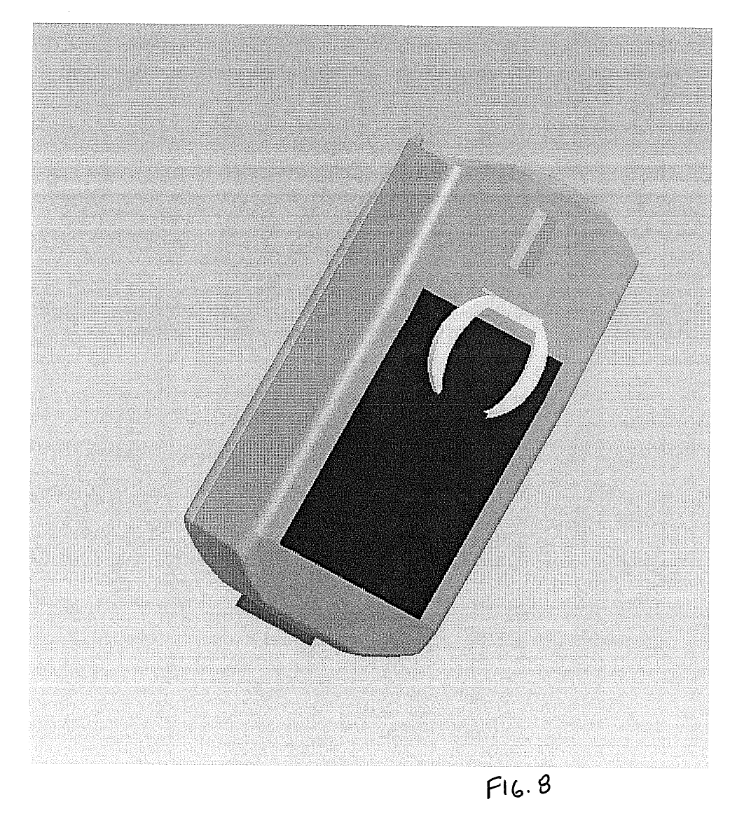

FIG. 9 is a rendering of an exploded view of an embodiment.

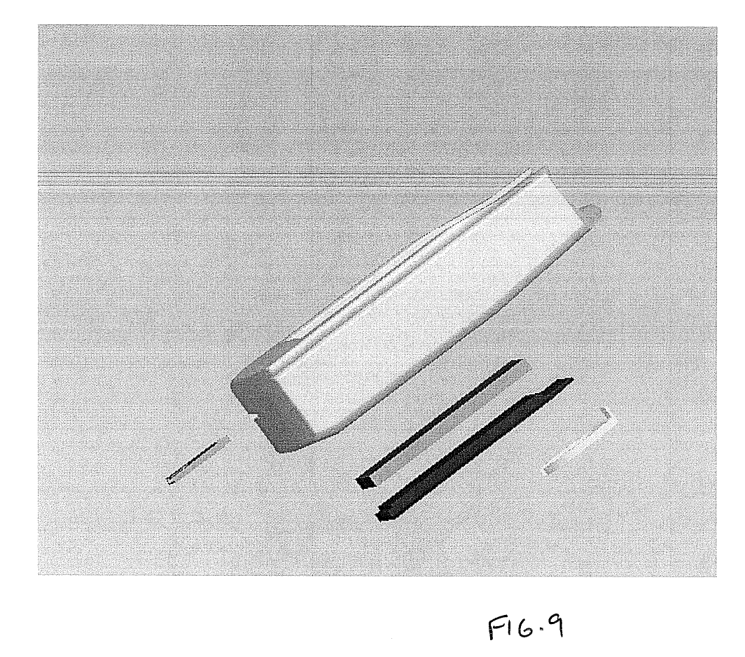

FIG. 10 is a rendering of an embodiment of the invention housing.

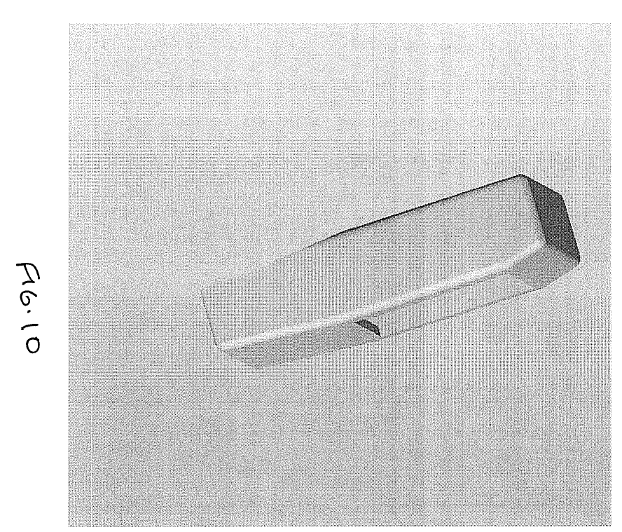

### REFERENCE NUMERALS USED IN THE DRAWINGS

holder battery 1
switch 2
diode 3
ground 4
pin connection to charger 5
ac/dc adapter plug 6
pin connection to device 7
portable device connection 8
portable device battery 9
battery 10
clip 11
recharging connection 12

### DETAILED DESCRIPTION OF THE INVENTION

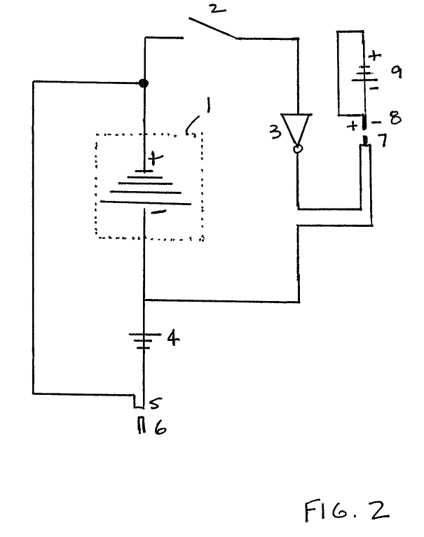

As shown in FIG. 2, a basic electrical diagram of the device shows the holder battery of the device 1. A switch 2 can be provided in the circuit to turn the device off and on. A diode 3 is provided in the circuit and the circuit is connected with a connection 7 to a portable electrical device having a connection 8 and rechargeable battery 9. The apparatus of the invention may also have a ground 4 and means for charging provided by a connector 5 which may be coupled with a charger connection 6 to a source of power, such as an electrical outlet.

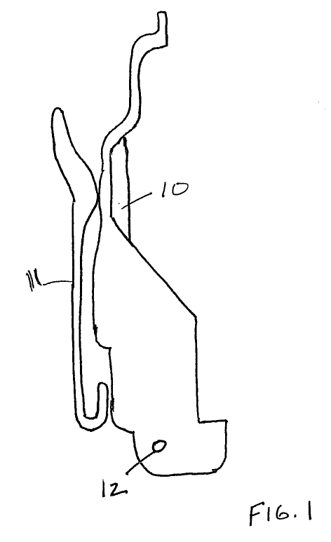

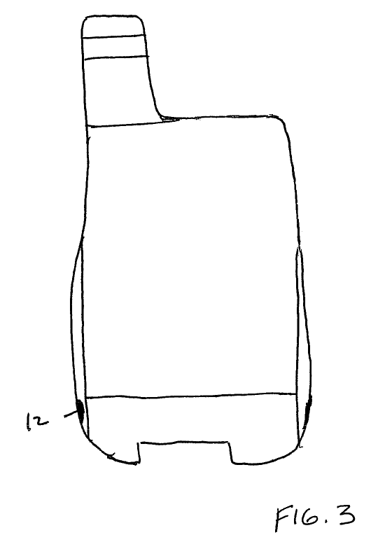

As an example of this invention, a mobile telephone belt holster could incorporate a charging device according to this invention. As shown in FIG. 1 and FIG. 3, a belt clip holster is shown. A rechargeable battery 10 is included into the body of a standard belt clip. Means for attaching the device to a user's belt or other location and to a telephone are included. Attachment to a user's belt or other location may be by a spring loaded clip 11. Means for securely and releasably holding the telephone are incorporated into the holder frame and may be adjustable to accommodate various telephones. The holder frame may also incorporate a recharging connection 12 to plug the device into an electrical outlet to charge the secondary battery or both the secondary battery and the rechargeable battery of the portable electronic device.

Other portable electrical devices may have similar external batteries to charge their rechargeable batteries. MP3 players, cameras, personal digital assistants (PDA's), and other devices that utilize rechargeable batteries may use this system.

It is preferred to have a design utilizing similar batteries of equal voltage and storage capacity, however larger capacity batteries may be beneficial in the clip, secondary battery. A switch on the device could allow charging of either the holder battery, or the holder battery and the device battery together when the portable device is attached to the holder of the invention. A switch may also allow charging of the device battery from the holder battery or turn off the charging, if desired.

Batteries in the secondary device of the invention could utilize any type of battery commonly used for portable electronic devices. Lithium ion, nickel metal hydride, and other types are known to be used and would be suitable for this invention.

An additional feature of the invention may be provided through the controls of the electronic device. For example, on a cellular telephone, the menus may access a power management screen that would allow the user to control usage of the supplemental battery. This may include when to use the supplemental battery, such as waiting until the main battery is depleted to a certain point, say 10 minutes left. The supplemental battery management may be optimized through management within the electronic device being charged.

It will be readily understood by those persons skilled in the art, that the present invention is susceptible to broad utility and application in changing light bulbs. Many embodiments and adaptations of the present invention, other than those described, as well as many variations, modifications, and equivalent arrangements, will be apparent from or reasonably suggested by the present invention and foregoing description thereof, without departing from the substance or scope of the invention.

While the foregoing description illustrates and describes exemplary embodiments of this invention, it is to be understood that the invention is not limited to the construction and design disclosed herein. The invention can be embodied in other specific forms without departing from the true invention.

What is claimed is:

1. A portable recharging device for portable electronic devices having a rechargeable battery comprising:
a battery,
means for retaining the portable electronic device,
means for charging the portable electronic device battery.

2. The portable recharging device according to claim 1, wherein the portable electronic device is a cellular telephone.

3. The portable recharging device according to claim 1, further comprising means for removably attaching the portable recharging device to objects.

4. The portable recharging device according to claim 3, wherein the means for removably attaching the portable recharging device is comprised of a belt clip.
